(19) United States
(12) Patent Application Publication
(10) Pub. No.: US 2002/0150814 A1
(43) Pub. Date: Oct. 17, 2002

(54) Battery

(76) Inventors: Brian Edward Causton, Reading (GB); Neville Lacey, Newbury Berkshire (GB); Larry Yu, Reading (GB)

Correspondence Address: ROBERT C. NABINGER, Fish & Richardson P.C., 225 Franklin Street, Boston, MA, 02110-2804, US

(21) Appl. No.: 09/773,962

(22) Filed: Feb. 1, 2001

(51) Int. Cl. H01M 2/12; H01M 2/02; H01M 12/06

(52) U.S. Cl. 429/82; 429/27; 429/164

(57) ABSTRACT

A battery includes a housing, an anode in the housing, a cathode in the housing, and a separator between the cathode and the anode. The housing has a surface adjacent to the cathode. The surface defines an opening, such as an elongated opening, adapted to facilitate a generally non-circular flux of gas on a portion of the cathode. The battery can provide relatively high current density and relatively high capacity.

### BACKGROUND

The invention relates to batteries.

Batteries are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material. In order to prevent direct reaction of the anode material and the cathode material, the anode and the cathode are electrically isolated from each other by a separator.

When a battery is used as an electrical energy source in a device, such as a cellular telephone, electrical contact is made to the anode and the cathode, allowing electrons to flow through the device and permitting the respective oxidation and reduction reactions to occur to provide electrical power. An electrolyte, for example, potassium hydroxide, in contact with the anode and the cathode contains ions that flow through the separator between the electrodes to maintain charge balance throughout the battery during discharge.

One configuration of a battery is a button cell, which has the approximate size and cylindrical shape of a button. In a button cell, a container for the anode and the cathode includes a lower cup-like structure, called a cathode can, and an upper cup-like structure retained within the cathode can, called an anode can. The anode can and the cathode can are separated by an insulator, such as an insulating gasket or seal. The anode can and the cathode can are crimped together to form the container.

In a metal-air electrochemical cell, oxygen is reduced at the cathode, and a metal, such as zinc, is oxidized at the anode. Oxygen is supplied to the cathode from the atmospheric air external to the cell through one or more air opening(s), such as circular holes, in the cell can. In zinc-air cells, the overall electrochemical reaction within the cell results in zinc metal being oxidized to zinc ions and O₂ from air being reduced to hydroxyl ions (OH⁻). Ultimately, zincate or zinc oxide is formed in the anode. While these chemical reactions are taking place, electrons are transferred from the anode to the cathode, providing power to the device.

Some digital devices, such as those used for telecommunication applications, can require relatively high voltages and currents from their electrical energy source. For example, some devices, such as cellular telephones operating under a Global System for Mobile (GSM) protocol, may demand a current cycle composed of a 1.42 A pulse for 0.5 msec and 135 mA pulses for 4.05 msec. Some analog devices may also demand a high drain constant current discharge, for example 500 mA.

During use, it is desirable to provide uniform discharge of the active materials and a relatively high discharge voltage profile. It is also desirable for the cell to have a long service life.

### SUMMARY

The invention relates to a battery, such as a metal-air battery, having a design that provides good air flow to a cathode of the battery. The design of the battery can provide uniform and sufficient air to the cathode surface, which provides uniform discharge and enhanced utilization of active materials. The battery can also produce a relatively high current density and have a relatively high capacity. The battery can be used for many applications, including, for example, those that require relatively high current densities and high power, such as telecommunication devices that operate under GSM protocols.

In one aspect, the invention features a battery including a housing, an anode in the housing, a cathode in the housing and a separator between the cathode and the anode. The housing has a surface adjacent to the cathode, and the surface defines an opening adapted to facilitate a generally non-circular, e.g., elongated, flux of gas on a portion of the cathode, wherein the opening is not a louver.

Embodiments of the invention may include one or more of the following features. The flux of gas can be generally oval or generally curvilinear. The surface defines openings adapted to facilitate, in combination, the generally non-circular flux of gas. The openings can be circular, elongated, generally straight, and/or curved. The surface defines openings symmetrically positioned in the housing. The battery can be a metal-air battery, a button cell, a cylindrical battery, or a prismatic battery.

In another aspect, the invention features a battery including a housing, an anode in the housing, a cathode in the housing, and a separator between the cathode and the anode. The housing has a surface adjacent to the cathode, and the surface defines an opening having an aspect ratio greater than 1, wherein the opening is not a louver.

Embodiments of the invention may include one or more of the following features. The aspect ratio is between about 3:2 and about 400:1, between about 5:1 and about 50:1, between about 15:1 and about 30:1, or between about 18:1 and about 26:1.

In another aspect, the invention features a battery including a housing, an anode in the housing, a cathode in the housing, and a separator between the cathode and the anode. The housing has a surface adjacent to the cathode, and the surface defines an elongated opening, wherein the opening is not a louver.

Embodiments of the invention may include one or more of the following features. The opening is substantially rectangular. The opening has a width between about 0.005 mm and about 0.50 mm, between about 0.02 mm and about 0.16 mm, or about 0.04 mm and about 0.08 mm. The opening has a length between about 0.05 mm and about 20.00 mm, between about 0.20 mm and about 4.00 mm, or between about 0.60 mm and about 1.20 mm. The opening is substantially straight or curved. The surface defines openings symmetrically positioned in the housing. The battery is a button cell, and the housing includes a cathode can having the surface. The opening extends radially from the center of the cathode can. The cathode can defines openings symmetrically positioned in the cathode can. The surface defines between 4 and 12, or between 8 and 12, openings symmetrically positioned and extending radially from the center of the housing. The cathode can defines rows, each row comprising multiple, collinear elongated openings. The cathode defines between 4 and 12 rows, or between 5 and 8 rows symmetrically positioned and extending radially from the center of the housing. Each row has between two and four elongated openings. The surface defines rows, each row having multiple elongated openings.

In another aspect, the invention features a metal-air battery capable of generating a Global System for Mobile pulse voltage greater than about 1.0 volt in less than about 30 seconds, such as, for example, in less than 20 seconds, in less than 10 seconds, in less than 5 seconds, and essentially instantaneously. The battery can include a housing defining an elongated opening that is not a louver.

In another aspect, the invention features a metal-air battery capable of undergoing a Global System for Mobile 900 simulation without dropping below about 1.0 volt for at least about 10 hours, such as, for example, for at least about 12 hours, and for at least about 14 hours. The battery can include a housing defining an elongated opening that is not a louver.

In another aspect, the invention features a battery cartridge including a casing, a battery in the casing, the battery, e.g., a metal-air battery, having an elongated opening; and a slide moveably engaged with the casing, the slide having an elongated opening alignable with the elongated opening of the battery.

The slide can be moveable between a first position in which the opening of the slide is aligned with the opening of battery, and a second position in which the opening of the slide is misaligned with the opening of battery. The slide can further be moveable to a third position in which the opening of the slide is partially aligned with the opening of the battery. The casing can have a prismatic shape, such as a rectangular prism. The battery can have a rectangular cross section or a triangular cross section.

In another aspect, the invention features a electrochemical power source having a metal-air battery system including an elongated opening and air control member arranged for relative sliding motion to variably cover the opening for controlling exposure to an oxygen-containing environment.

In another aspect, the invention features a battery cartridge including a casing, a battery in the casing, the battery including a cathode having a first side and a second side, a first layer disposed adjacent to the first side of the cathode, the first layer being electrically-insulating, an anode disposed adjacent to the first layer, and a second layer disposed adjacent to the second side of the cathode, the second layer being air-permeable and liquid-impermeable and defining an exterior surface of the battery, and a slide moveably engaged with the casing, the slide defining an elongated opening. The battery can be a metal-air battery having, for example, a substantially rectangular cross section or a substantially square cross section.

In another aspect, the invention features a battery including a housing, an anode in the housing, a cathode in the housing, and a separator between the cathode and the anode. The housing has a surface adjacent to the cathode, and the surface defines an elongated opening.

As used herein, “battery” means one electrochemical cell, or a multiplicity of electrochemical cells connected together in series or in parallel or both.

As used herein, “adjacent” means nearby, and does not necessarily mean immediately next to.

Other features, objects, and advantages of the invention will be apparent from the description and drawings, and from the claims.

### DESCRIPTION OF THE DRAWINGS

FIG. 1 is a cross-sectional view of an embodiment of a metal-air battery;

FIG. 2 is a perspective view of an embodiment of a cathode can;

FIG. 3 is a flux contour plot of one-quarter of an embodiment of a cathode can having circular air access openings;

FIG. 4 is a flux contour plot of one-eighth of an embodiment of a cathode can having non-circular air access openings;

FIG. 5 is a flux contour plot of one-eighth of an embodiment of a cathode can having non-circular air access openings;

FIG. 6 is a flux contour plot of one-eighth of an embodiment of a cathode can having non-circular air access openings;

FIG. 7 is a flux contour plot of one-eighth of an embodiment of a cathode can having non-circular air access openings;

FIG. 8 is a flux contour plot of one-eighth of an embodiment of a cathode can having non-circular air access openings;

FIG. 9 is a flux contour plot of one-eighth of an embodiment of a cathode can having non-circular air access openings;

FIG. 10 is a schematic of an embodiment of an elongated opening and a flux contour plot;

FIG. 11 is a bottom view of an embodiment of a cathode can;

FIG. 12 is a flux contour plot of a portion of an embodiment of a cathode can having circular air access openings;

FIG. 13 is a perspective view of an embodiment of a cathode can with non-circular air access openings;

FIG. 14 is a flux contour plot of a portion of an embodiment of a cathode can having non-circular air access openings.

FIG. 15 is a perspective view of an embodiment of a can with non-circular air access openings;

FIG. 16 is a perspective view of an embodiment of a battery cartridge;

FIG. 17 is a plot of energy density vs. specific power for multiple embodiments of cells;

FIG. 18 is a plot of anode utilization vs. constant power discharge for multiple embodiments of cells;

FIG. 19 is a plot of time (in seconds) for high pulse voltages of multiple embodiments of cells, under GSM 900 simulation, to exceed about 1.0 volt; and

FIG. 20 is a plot of time (in minutes) for high drain pulse voltages of multiple embodiments of cells, under GSM 900 simulation, to reduce to less than about 1.0 volt.

### DETAILED DESCRIPTION

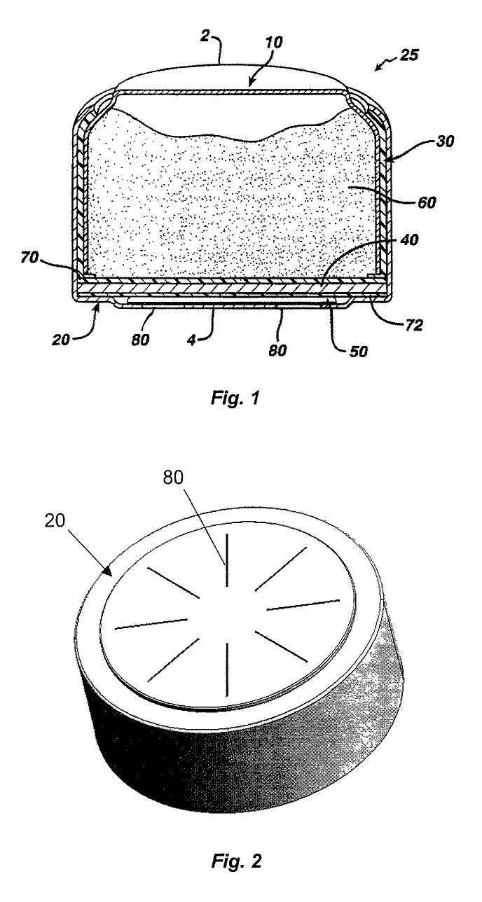

Referring to FIG. 1, a button cell 25, such as a metal-air button cell, includes an anode 2 and a cathode 4. Anode 2 includes an anode can 10 and anode gel 60. Cathode 4 includes a cathode can 20 and a cathode structure 40. An insulator 30 is located between anode can 10 and cathode can 20. A separator 70 is located between cathode structure 40 and anode gel 60, preventing electrical contact between these two components. A membrane 72 helps prevent the electrolyte from leaking out of cell 25. Air access slots 80, located in cathode can 20, allows air to exchange into and out of cell 25. An air disperser 50 is located between air access slots 80 and cathode structure 40. Anode can 10 and cathode can 20 are crimped together to form a housing for cell 25. When not undergoing discharge, cell 25 may be stored in a sealed or unsealed condition.

Referring to FIG. 2, cathode can 20 defines eight slots 80 that serve as air access openings for cell 25. Slots 80 can be accurately formed, for example, by laser cutting. Slots 80 are symmetrically distributed on the bottom side of cathode can 20, which helps to provide uniform access of air to cell 25. In particular, slots 80 are preferably not louvers as described in commonly assigned U.S. Ser. No. 09/374,277, filed Aug. 13, 1999, and entitled “Metal-Air Battery Container”.

Typically, the dimensions, configurations, and positions of slots 80 are designed to provide cell 25 with high voltage and high capacity. Without wishing to be bound by any theory, it is believed that the performance of cell 25 is a function of diffusion-controlled air flow, vis-à-vis, convection-controlled air flow. Accordingly, by providing cathode can 20 with slots defining relatively large areas, a relatively large amount of air flux can interact with cathode 40, thereby allowing cell 25 to generate a relatively high voltage, such as a GSM pulse.

Increasing the areas defined by air access openings by using slots 80 can also enhance the capacity of cell 25. Without wishing to be bound by any theory, it is believed that one reason for failure of metal-air cells is “clogging” of portions of the separator that are adjacent to portions of the cathode adjacent to the air access openings. As zincate migrates into the separator, the zincate can precipitate into zinc oxide due to changes in pH near the air access openings. Then, as the concentration of zinc oxide increases, localized portions of the separator can eventually be blocked by zinc oxide, thereby reducing the capacity of the cell. Thus, by providing cathode can 20 with air access openings that diffuse or spread out the diffusional flux of air entering cell 25, it is possible to minimize relatively localized concentrations of zincate, which can form separator-clogging zinc oxide and reduce the capacity of cell 25.

Generally, increasing the total area defined by slots 80, such as the area defined by each slot and the number of slots, can decrease the capacity of cell 25. For example when the cell is left unsealed, carbon dioxide can react with a potassium hydroxide electrolyte to form potassium carbonate (“carbonation”), and the battery can become dry because water from the electrolyte evaporates (“dry out”). However, it is believed that the anode utilization of cell 25 can be increased, for example, from 0% for four 0.6 mm diameter circular holes up to about 65% on a 25mW constant power discharge to 1.0V, because the increased path length defined by slots 80 improves diffusion flux relative to air access port area and minimizes clogging of the separator. Nevertheless, there is an upper limit on the total area defined by slots 80 because carbonation and dry out can overcome the enhancement in capacity.

Thus, underexposure to air can provide less than optimum performance of the cell (e.g., insufficient power) because an insufficient amount of oxygen can contact the cathode. Overexposure to air can lead to premature degradation of the materials in the battery. Both situations can lead to poor cell performance.

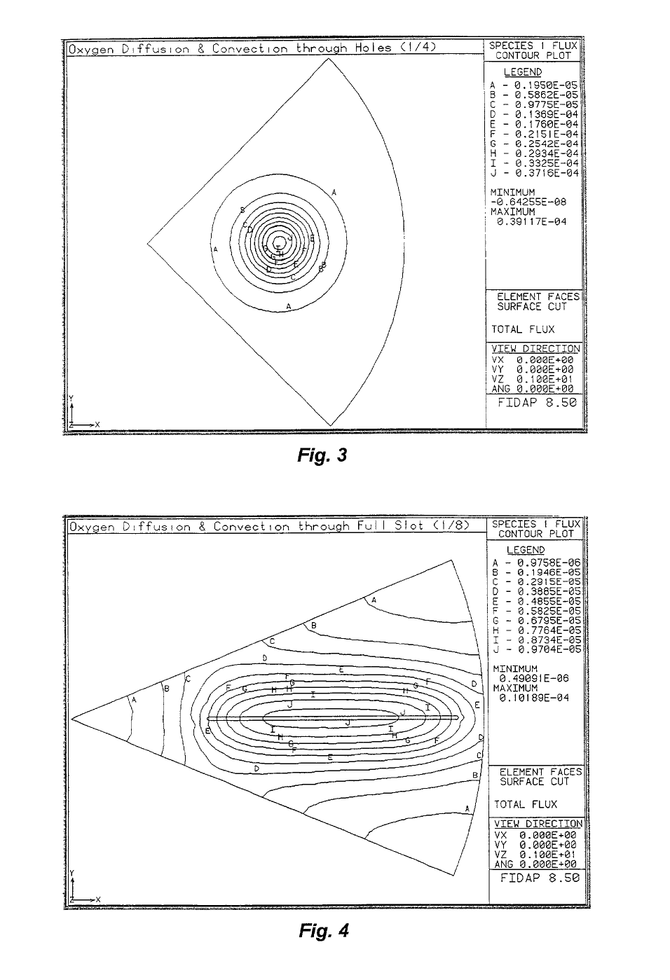

The design of good air access openings can be assisted by studying the diffusion of air through the openings. FIGS. 3 and 4 show a contour plot of air flux for a cathode can defining a circular air access opening and a slot, respectively. The contour plots were generated by computational fluid dynamics (CFD) modeling using a flow modeling tool, such as FIDAP v. 8.50, available from Fluent, Inc. FIDAP v. 8.50 software was used for simulation of oxygen supply, as described in Appendix A, hereby incorporated by reference in its entirety.

FIG. 3 shows that a circular air access opening (0.6 mm in diameter) facilitates or provides a circular flux of air (or oxygen) on a portion of the cathode adjacent to the air access opening. The portion of the cathode directly below the air access opening (labeled “J”) indicates an area with relatively high oxygen flux. This oxygen flux decreases radially away from the air access opening, indicating diminishing oxygen flux, which is represented by decreasing alphabet letters (J to A). It is believed that the areas marked by the lower alphabetic letters are oxygen-poor, e.g., all the oxygen that could be consumed by the cathode exceeds available oxygen. The higher alphabetic letters, it is believed, represent oxygen-rich areas, which can enhance localized precipitation of zinc oxide in the area of separator nearest to the region of cathode with high oxygen concentration, which may result in blocking or clogging of the separator, thereby reducing the capacity the cell may utilize.

In comparison, FIG. 4 shows that a slot (0.04 mm wide and 2.70 mm long) facilitates or provides a non-circular, diffused flux of oxygen on a portion of the cathode adjacent to the slot. The flux of oxygen is relatively high near portions of the cathode below the slot and decreases for portions of cathode farther away from the slot. Generally, however, the slot provides an overall flux of oxygen on the cathode that is diffused, for example, compared to the above circular air access opening. It is believed that diffusing the flux of oxygen minimizes localized concentrations of zincate that can form separator-blocking zinc oxide. This, in turn, can enhance consumption of active materials and enhance capacity. Also, since the slots can allow a relatively high, and diffused, flux of oxygen to enter the cell, the current density of the cell can also be enhanced.

Thus, slots 80 are generally configured to provide a non-circular oxygen flux on a portion of cathode 40. Slots 80 are elongated openings, such as, for example, an oval opening, an elliptical opening. Slots 80 can be shaped as parallelograms, such as a rectangle, with sharp corners or curved corners. Slots 80 can have parallel or non-parallel sides. Slots 80 can defined by straight lines or curvilinear. The ends of slots 80 may be curved, semi-circular or straight, but they are not limited to these configurations.

The oxygen flux on cathode 40 is generally elongated, having, for example, a generally oval shape, a generally elliptical shape, a generally arcuate shape, or a generally racetrack-like shape, e.g., having a perimeter that is elongated and a pair of generally parallel edges. An example of a non-circular oxygen flux is shown in FIGS. 4.

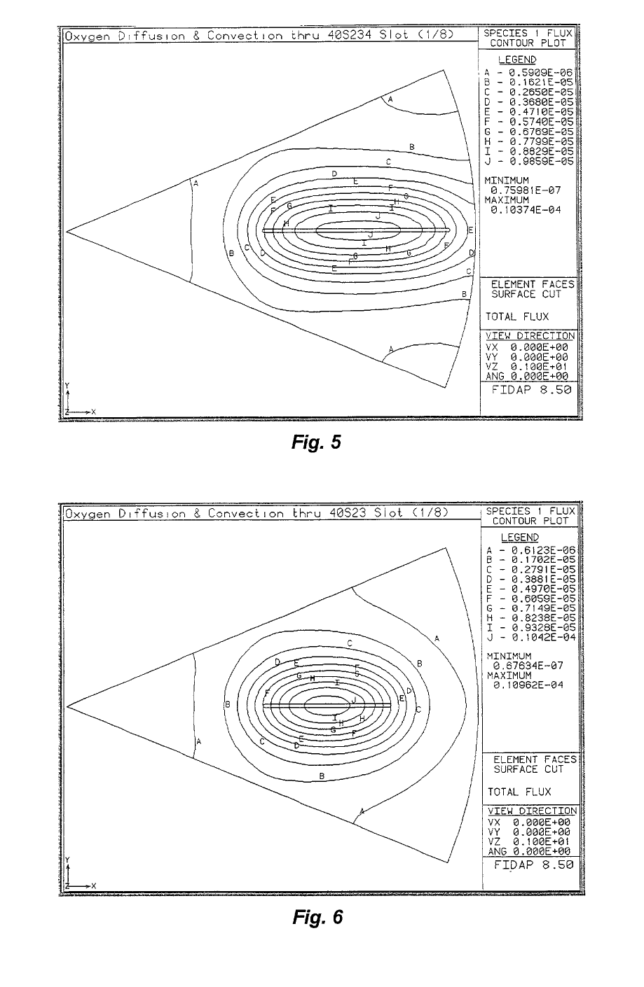

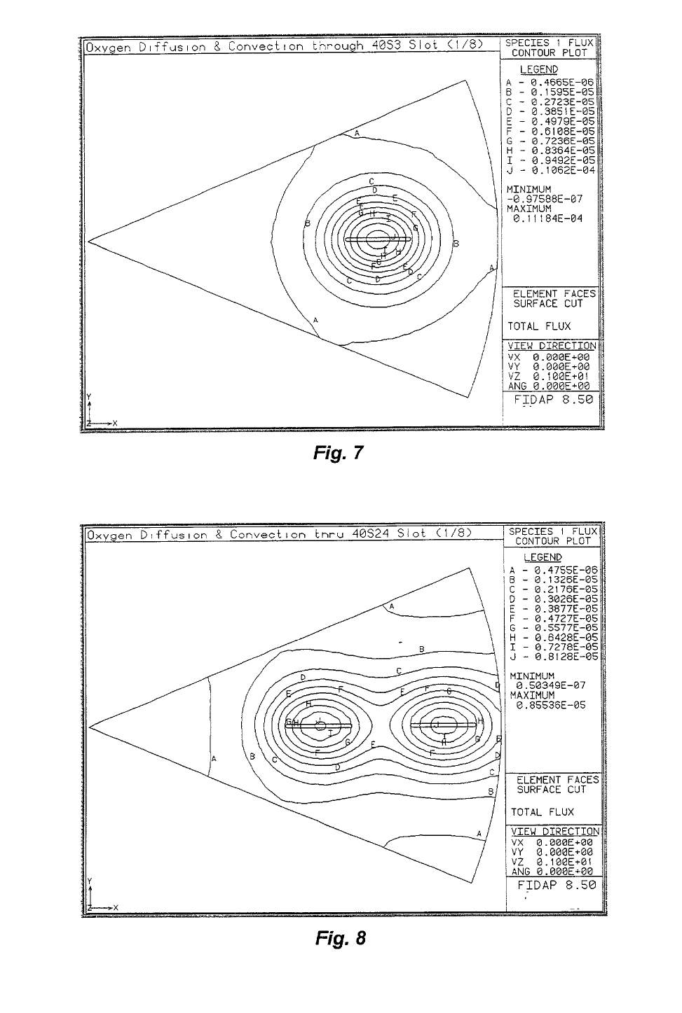

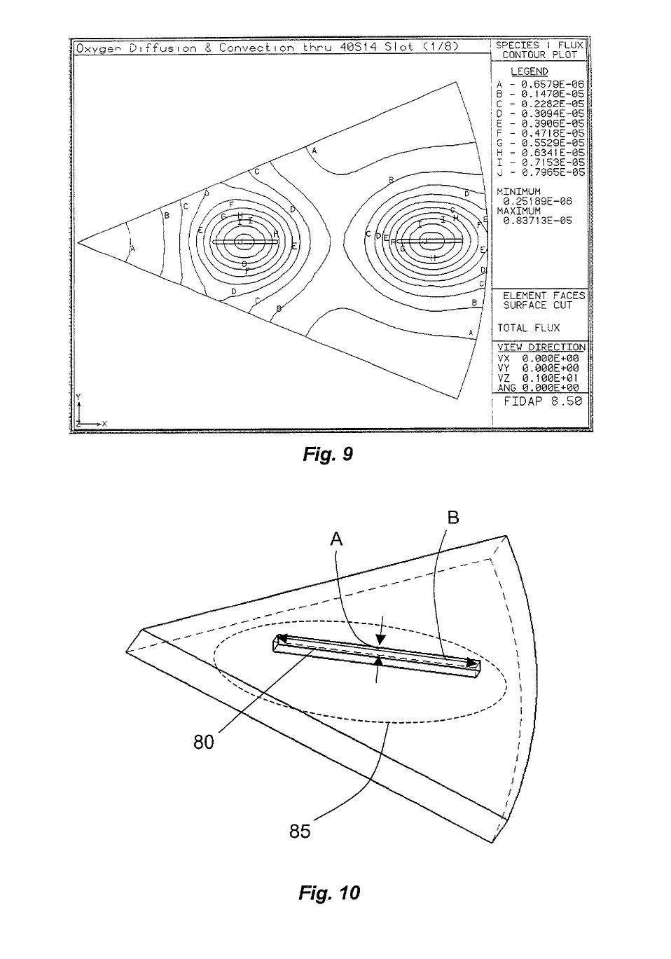

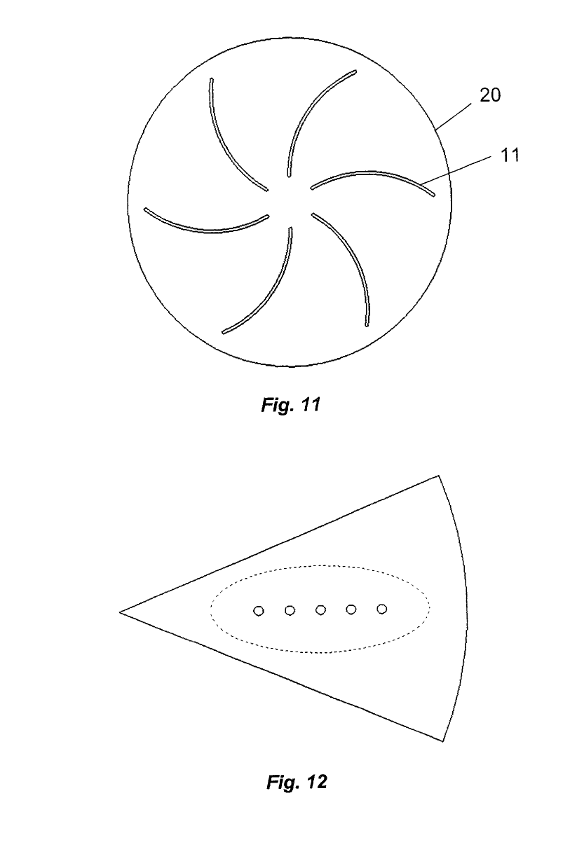

FIGS. 4-9 show some examples of configurations of straight slots that can provide a non-circular oxygen flux. Referring to FIGS. 4-7, a non-circular oxygen flux can be formed by using varying lengths of slots, e.g., to form varying degrees of elongation and diffusivity of the oxygen flux, which, in turn, affects current density and capacity. FIG. 6 shows relatively short slot, here, one-half the length of the slot shown in FIG. 4; FIG. 7 shows a slot one-fourth the length of the slot shown in FIG. 4; and FIG. 5 shows a slot three-quarters the length of the slot shown in FIG. 4. FIG. 9 shows two slots that provide non-circular oxygen fluxes that do not overlap. FIG. 8 shows two slots that are closer together than those shown in FIG. 9 and therefore have higher total oxygen flux; the two slots form, in combination, one elongated, non-circular oxygen flux on the cathode. Generally, the slots can be any shape and size, or configured at any position, that enhances the performance of the cell. For example, FIG. 11 shows multiple non-straight, e.g., curved, slots can be used in combination to form a non-circular oxygen flux on the cathode. These non-straight slots may also be interrupted as per the straight slots shown in FIGS. 8 and 9.

Particular configurations of slots 80, for example, number, positions, shape and size of slots 80, are a function of multiple parameters. These parameters include, but are not limited to, application power demand, e.g., high, medium or low; mode of operation, e.g., analog or digital; cathode characteristics, e.g., rate capability, porosity, number of layers, etc; cell build parameters, e.g., form factor (such as button, prismatic, cylindrical), air plenum height, cathode can wall thickness, etc; embodiment of final use, e.g., single cell or multi-cell pack; and air access configuration of final embodiment, e.g., single or multi-sided, with or without additional air-management systems. In particular, the mode of operation and device power needs can a large effect on air-access configuration requirements, for example, GSM protocols as used by cellular telephones have relatively rapid pulse frequencies alternating between high and low currents. Furthermore, some digital devices require a specific voltage to function, while some analog devices exhibit a gradual deterioration in performance prior to failure. Also, different cathode formulations may have different characteristics, e.g., current density capabilities. A cathode that can provide a current density of, for example, 40 mA/cm² at 1.1V, may require a different slot configuration than a cathode that can provide, for example, 70 mA/cm² at 1.1V, to provide optimal performance under specified conditions of discharge. To achieve similar output currents for a given voltage level, the cathode that can provide 40 mA/cm² at 1.1V typically requires greater surface oxygen coverage than the one that can provide 70 mA/cm² at 1.1V. However, comparing surface area to surface area, slots typically provide relatively high limiting current performance compared to holes, until the maximum current density of the cathode has been reached by the holes. For example, there is typically a maximum current that a cathode can provide at a given voltage. In the case of metal-air cells, the maximum current density is governed, among other things, by oxygen distribution. It is possible to use enough circular holes that define either low or high surface area to achieve this maximum possible current density. Once the maximum current density has been achieved by circular holes, this performance typically cannot be exceeded by slots. However, compared to circular holes, slots can typically achieve the maximum current density by defining less surface area.

The widths and lengths of slots 80 can also be a function of the size of cathode can 20, which is dependent on the size of cell 25. Generally, each slot 80 has a width of about 0.005 mm to about 0.50 mm, preferably about 0.02 mm to about 0.16 mm, and more preferably about 0.04 mm to about 0.08 mm. Generally, the lengths of slots 80 vary from about 0.05 mm to about 20.00 mm, preferably about 0.20 mm to about 4.00 mm, and more preferably about 0.60 mm to about 1.20 mm. For example, for a 675 cell (IEC designation “PR44”), each slot 80 is preferably about 0.04 mm to about 0.08 mm wide, and about 0.60 mm to about 3.00 mm long.

The shape of slots 80 can also be expressed according to an aspect ratio. Referring to FIG. 10, the aspect ratio of slot 80 is defined as the ratio of the width of the slot through its center (line A) to the length of the slot through its center (line B). For example, the aspect ratio of a circular opening is 1:1. The aspect ratio of slots 80 is generally greater than 1:1, and can vary from about 3:2 to about 400:1; preferably about 5:1 to about 50:1; and more preferably, about 15:1 to about 30:1.

In addition to slots 80 described above, other configurations of air access openings can be used to provide elongated and diffused oxygen fluxes. For example, FIG. 11 shows a cathode can defining multiple curved slots 110. Curved slots 110 can be configured similarly to slots 80. FIG. 12 shows that elongated and diffused oxygen fluxes can be provided by circular air access openings that are configured and positioned such that their individual oxygen fluxes partially overlap to provide one elongated, non-circular oxygen flux, similar to the example of FIG. 10. For a button cell, radially emanating, wedge-shaped slots with the narrow end of the slots at the center may be useful because the geometry of the air plenum is such that the central portion of the cell typically requires a smaller quantity of oxygen to be provided than the periphery of the cell.

Other features of cell 25 will now be described.

Anode can 10 includes a tri-clad or bi-clad material. The bi-clad material is generally stainless steel with an inner surface of copper. The tri-clad material is composed of stainless steel having a copper layer on the inner surface of the can and a nickel layer on the outer surface of the can. Anode can 10 may include a surface comprised of tin or its alloys or other agents on the inner surface in contact with anode gel 60. Preferably, the tin is on the inside surface of the anode can that makes contact with the zinc anode and the electrolyte. The tin may be a continuous layer on the inner surface of the can. The tin layer may be a plated layer having a thickness between about 1 and 12 microns, preferably between about 2 and 7 microns, and more preferably about 4 microns. The tin may be pre-plated on the metal strip or post-plated on the anode can. For example, the tin can be deposited by immersion plating (e.g., using a plating solution available from Technics, Rhode Island). The plated layer can have a bright finish or a matte finish. The coating may also include silver or gold compounds.

Cathode can 20 is composed of cold-rolled steel having inner and outer layers of nickel. There is an insulator, such as an insulating gasket, that is pressure-fit between anode can 10 and cathode can 20. The gasket can be thinned to increase the capacity of the cell.

The can configuration may have a straight wall design, in which the side wall of anode can 10 is straight, or a foldover design. The foldover design is preferred for thinner-walled cans, e.g., those having a thickness of about 4 microns or less. In a foldover design, the clip-off edge of anode can 10, which is generated during stamping of the can, is placed on the top, outside of the can, away from the interior of the cell. The foldover design can reduce potential gas generation by decreasing the possibility of zinc making contact with exposed stainless steel at the anode can clip-off edge. A straight wall design can be used in conjunction with an L- or J-shaped insulator, preferably J-shaped, that can bury the clip-off edge into the insulator foot. When a foldover design is used, the insulator can be L-shaped.

Overall cell height and diameter dimensions are specified by the International Electrotechnical Commission (IEC). Button cell 25 can have a variety of sizes: a 675 cell (IEC designation “PR44”) has a diameter between about 11.25 and 11.60 millimeters and a height between about 5.0 and 5.4 millimeters; a 13 cell (IEC designation “PR48”) has a diameter between about 7.55 and 7.9 millimeters and a height between about 5.0 and 5.4 millimeters; a 312 cell (IEC designation “PR41”) has a diameter between about 7.55 and 7.9 millimeters and a height of between about 3.3 and 3.6 millimeters; and a 10 cell (IEC designation “PR70”) has a diameter between about 5.55 and 5.80 millimeters and a height between about 3.30 and 3.60 millimeters. A 5 cell has a diameter between about 5.55 and 5.80 millimeters and a height between about 2.03 and 2.16 millimeters. Cell 25 can have an anode can thickness of about 0.1016 mm. Cell 25 can have a cathode can thickness of about 0.1016 mm.

During storage, air access openings 80 are typically covered by a removable sheet, commonly known as a seal tab, that is provided on the bottom of cathode can 20 to cover the air access openings to restrict the flow of air between the interior and exterior of button cell 25. A user peels the seal tab from cathode can 20 prior to use to activate the cell. This allows oxygen from the air to enter the interior of button cell 25 from the external environment.

Cathode structure 40 can include an active cathode mixture and a current collector in electrical contact with cathode can 20. The active cathode mixture may include a catalyst for reducing oxygen, such as a manganese compound, carbon particles, and a binder. Useful catalysts include manganese oxides, such as Mn₂O₃, Mn₃O₄, and MnO₂, that can be prepared, for example, by heating manganese nitrate or by reducing potassium permanganate. Cathode structure 40 includes between about 1% and about 10%, preferably between about 3% and about 5% of catalyst by weight.

The carbon particles are not limited to any particular type of carbon. Examples of carbon include Black Pearls 2000, Vulcan XC-72 (Cabot Corp., Billerica, Mass.), Shawinigan Black (Chevron, San Francisco, Calif.), Printex, Ketjen Black (Akzo Nobel, Chicago, Ill.), and Calgon PWA (Calgon Carbon, Pittsburgh, Pa.). Generally, the cathode mixture includes between about 30% and about 70%, preferably between about 50% and about 60%, of total carbon by weight.

Examples of binders include polyethylene powders, polyacrylamides, Portland cement and fluorocarbon resins, such as polyvinylidene fluoride and polytetrafluoroethylene. An example of a polyethylene binder is sold under the tradename Coathylene HA-1681 (Hoechst). A preferred binder includes polytetrafluoroethylene (PTFE) particles. Generally, the cathode mixture includes between about 10% and 40%, preferably between about 30% and about 40%, of binder by weight.

The cathode mixture is formed by blending the catalyst, carbon particles and binder, and is then coated on the current collector, such as a metal mesh screen, to form cathode structure 40. After the cathode mixture has hardened, cathode structure 40 is heated to remove any residual volatiles.

On the interior side of cathode structure 40, separator 70 is placed adjacent to the cathode structure. Separator 70 can be a porous, electrically insulating polymer, such as polypropylene, that allows electrolyte to contact cathode structure 40.

On the exterior side of cathode structure 40, membrane 72 is placed adjacent to the cathode structure. Membrane 72 is air-permeable and liquid-impermeable. Membrane 72, e.g., a PTFE membrane, helps maintain a consistent humidity level in cell 25. Membrane 72 also helps to prevent the electrolyte from leaking out of the cell and CO₂ from leaking into the cell.

Air disperser 50 is a porous or fibrous material, such as porous paper, that helps maintain an air diffusion space between membrane 72 and cathode can 20.

Anode gel 60 contains a mixture of zinc and electrolyte. The mixture of zinc and electrolyte can include a gelling agent that can help prevent leakage of the electrolyte from the cell and helps suspend the particles of zinc within the anode.

The zinc material can be a zinc powder that is alloyed with lead, indium, aluminum, or bismuth. For example, the zinc can be alloyed with between about 400 and 600 ppm (e.g., 500 ppm) of lead, between 400 and 600 ppm (e.g., 500 ppm) of indium, or between about 50 and 90 ppm (e.g., 70 ppm) aluminum. Preferably, the zinc material can include lead, indium and aluminum, lead and indium, or lead and bismuth. Alternatively, the zinc can include lead without another metal additive. The zinc material can be air blown or spun zinc. Suitable zinc particles are described, for example, in U.S. Ser. No. 09/156,915, filed Sep. 18, 1998, U.S. Ser. No. 08/905,254, filed Aug. 1, 1997, and U.S. Ser. No. 09/115,867, filed Jul. 15, 1998, each of which is incorporated by reference in its entirety.

The particles of the zinc can be spherical or nonspherical. For example, the zinc particles can be acicular in shape (having an aspect ratio of at least two). The zinc material includes a majority of particles having sizes between 60 mesh and 325 mesh. For example, the zinc material can have the following particle size distribution:

0-3 wt % on 60 mesh screen;

40-60 on 100 mesh screen;

30-50 wt % on 200 mesh screen;

0-3 wt % on 325 mesh screen; and

0-0.5 wt % on pan.

Suitable zinc materials include zinc available from Union Miniere (Overpelt, Belgium), Duracell (USA), Noranda (USA), Grillo (Germany), or Toho Zinc (Japan).

The gelling agent is an absorbent polyacrylate. The absorbent polyacrylate has an absorbency envelope of less than about 30 grams of saline per gram of gelling agent, measured as described in U.S. Pat. No. 4,541,871, incorporated herein by reference. The anode gel includes less than 1 percent of the gelling agent by dry weight of zinc in the anode mixture. Preferably the gelling agent content is between about 0.2 and 0.8 percent by weight, more preferably between about 0.3 and 0.6 percent by weight, and most preferably about 0.33 percent by weight. The absorbent polyacrylate can be a sodium polyacrylate made by suspension polymerization. Suitable sodium polyacrylates have an average particle size between about 105 and 180 microns and a pH of about 7.5. Suitable gelling agents are described, for example, in U.S. Pat. Nos. 4,541,871, 4,590,227, or 4,507,438.

In certain embodiments, the anode gel can include a non-ionic surfactant. The surfactant can be a non-ionic phosphate surfactant, such as a non-ionic alkyl phosphate or a non-ionic aryl phosphate (e.g., RA600 or RM510, available from Rohm & Haas) coated on a zinc surface. The anode gel can include between about 20 and 100 ppm of the surfactant coated onto the surface of the zinc material. The surfactant can serve as a gassing inhibitor.

The electrolyte can be an aqueous solution of potassium hydroxide. The electrolyte can include between about 30 and 40 percent, preferably between 35 and 40 of potassium hydroxide. The electrolyte can also include between about 1 and 2 percent of zinc oxide.

Other embodiments of metal-air cells are described, for example, in commonly-assigned U.S. Ser. No. 09/427,371, filed on Oct. 26, 1999, and entitled “Cathodes for Metal Air Electrochemical Cells”, hereby incorporated by reference in its entirety. The cathodes described herein can also be used in other cell forms, such as prismatic cells.

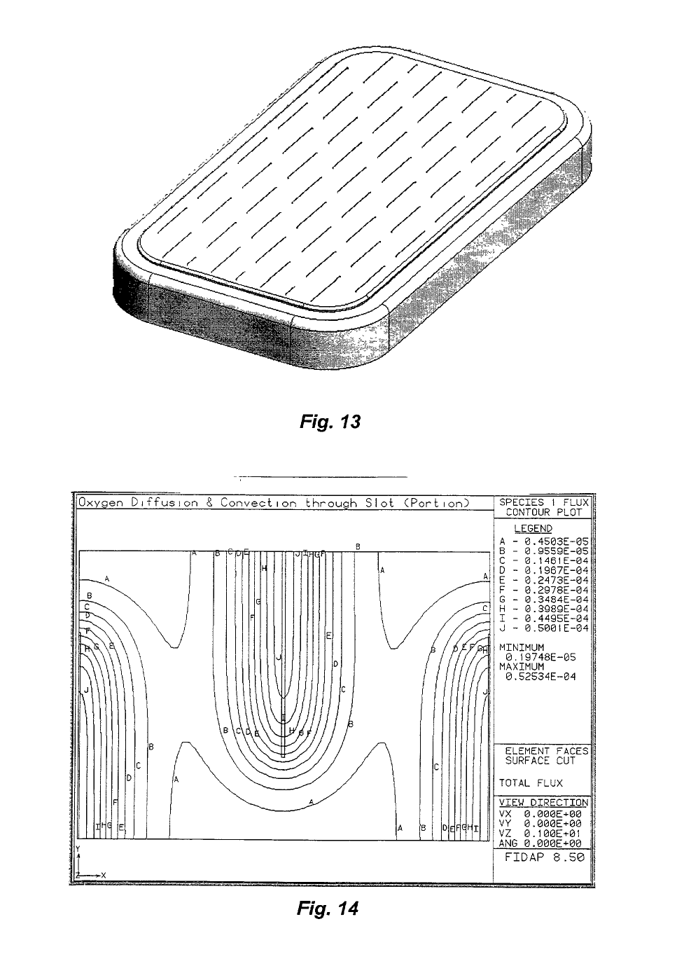

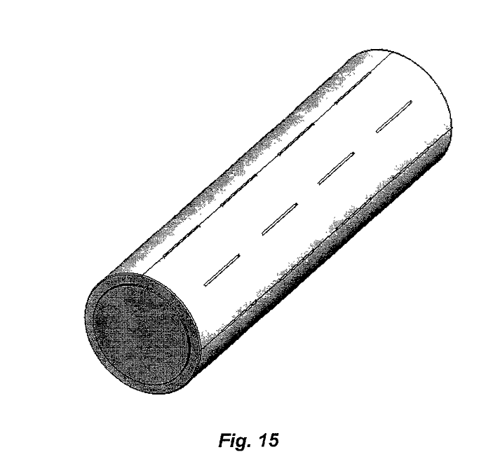

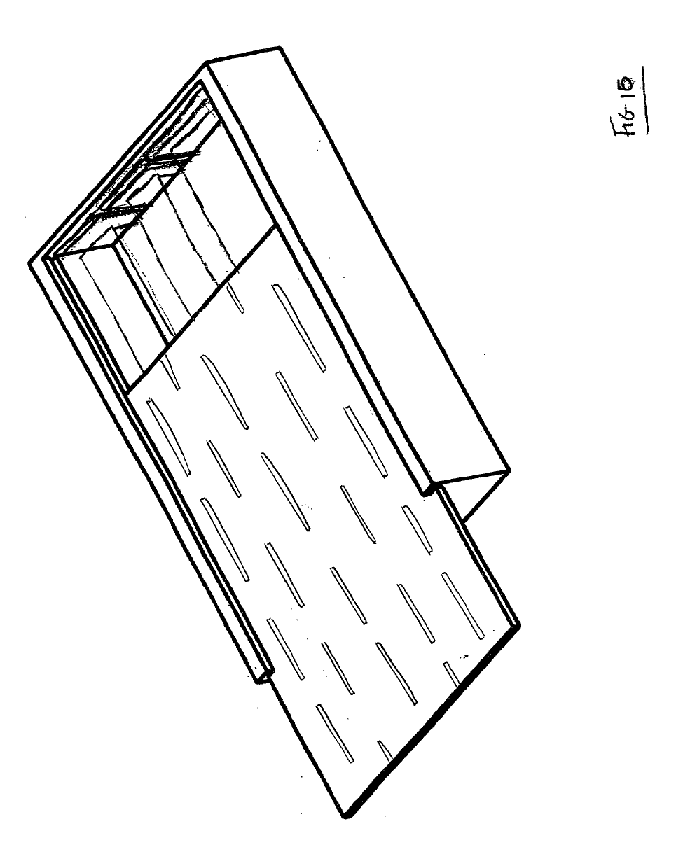

In some embodiments, cell 25 can have forms other than a button cell, such as, for example, a prismatic cell (FIG. 13), the flux contour plot for which is shown in FIG. 14, a cylindrical cell (FIG. 15), and a racetrack cell. For example, a cylindrical cell may include six equally spaced rows of slots, each row composed of three slots in line from the top to the bottom of the cell, or six equally spaced rows of slots, each row composed of twelve slots in line from the top to the bottom of the cell. Placement and number of slots can be similar to placement and number of louvers, as described in U.S. Ser. No. 09/374,277. Cell 25 can also be, for example, an air-recovery or air-assist cell. In some embodiments, slots 80 are provided in a plastic or metal cartridge capable of containing a single cell or multiple cells, such as canless cells and metal-air cells with alignable slots, where the slots in the cartridge are adjacent to the cathode structure (FIG. 16). Such embodiments are described in commonly-assigned U.S. Ser. No. 09/693,010, filed Oct. 20, 2000, and entitled “Battery System”, and Provisional Application No. ______ , filed Feb. 1, 2001, and entitled “Battery”, all hereby incorporated by reference in their entirety. In some embodiments, the cartridge may contain double cathode cells in which case the slots may be on both the back and front of the cartridge.

In some embodiments, cell 25 includes more than one seal tab. To use the cell, a user removes one tab to expose a set of air access openings. As the separator becomes blocked near these exposed openings, the user can remove another tab to expose another set of air access openings, thereby enabling the user to continue to use the cell.

All publications and patents mentioned in this application are herein incorporated by reference to the same extent as if each individual publication or patent was specifically and individually indicated to be incorporated by reference.

The following examples are illustrative and not intended to be limiting.

### EXAMPLES

Experimental air-access configurations were prepared by laser cutting slots of various designs in virgin nickel plated steel 675 (IEC PR44) sized cathode cans. The slots radiated from the center portion of the cathode can and each slot was equidistant at a given locus from its two neighboring slots. Slots (0.04 mm wide) were cut with the following configurations: 6×3.56 mm long curved slots, total slot area 0.855 mm²; 6×3.56 mm curved slots with the central 1.19 mm not removed (i.e., 12×1.19 mm slots in sets of two), total slot area 0.564 mm²; and 8×2.70 mm straight slots, total slot area 0.863 mm².

Experimental cathode cans were randomly mixed with each other and with a control group having 4×0.6 mm holes, total slot area 1.131 mm². Cellulosic air diffusion layers, PTFE air diffusion layers and pre-assembled cathode plaque were punched from strips into the cathode cans to form cathode sub-assemblies. The cathode subassemblies were then taken to a production line and made into 675 (IEC PR44) cells.

Discharge tests were carried out at 20° C. Data was collected using a Maccor series 4000 datalogger. A series of continuous constant power tests in the range 10-30 mW was conducted using an end-point voltage of 1.0V. Simulated GSM 900 discharges were also performed. Pulsed currents were provided on a continuous basis as follows: 98 mA for 0.55 ms, and 9.3 mA for 4.05 ms.

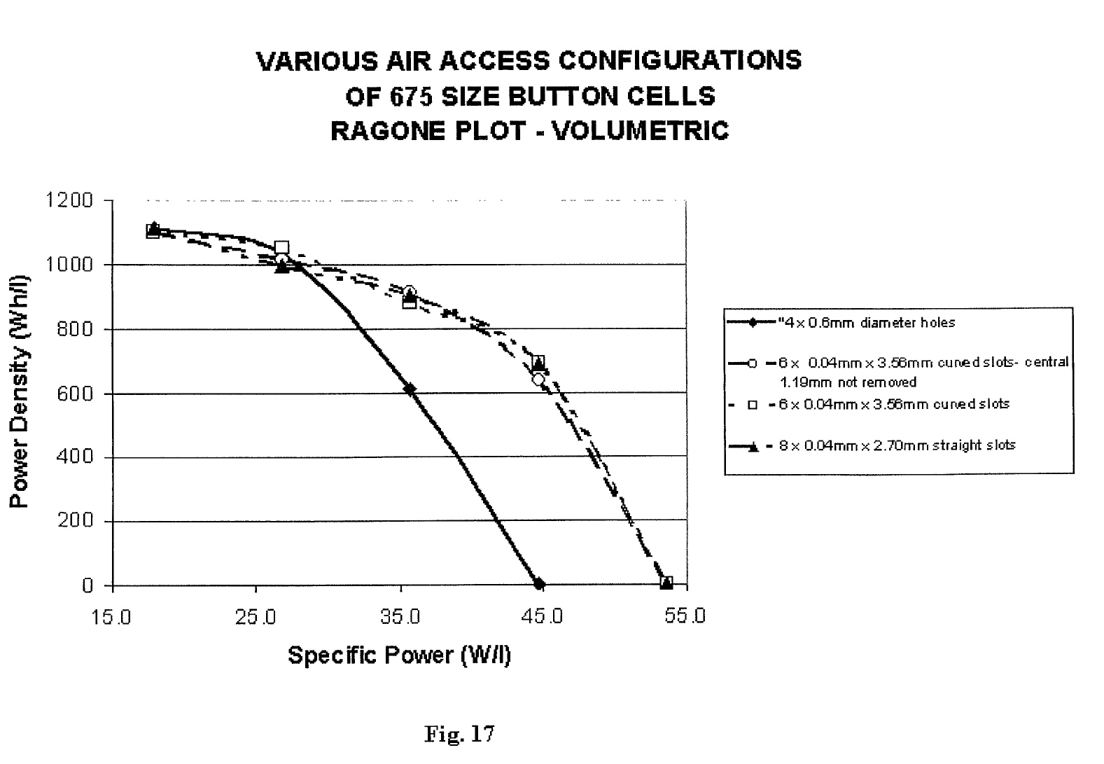

FIG. 17 is a volumetric Ragone plot (power density vs. specific power) for the multiple embodiments of cells described above. FIG. 17 shows that the slotted air access configurations provided improved energy density at specific power levels of 30 W/l and greater, compared to the 4 round holes configuration, which had at least 24% greater total surface area.

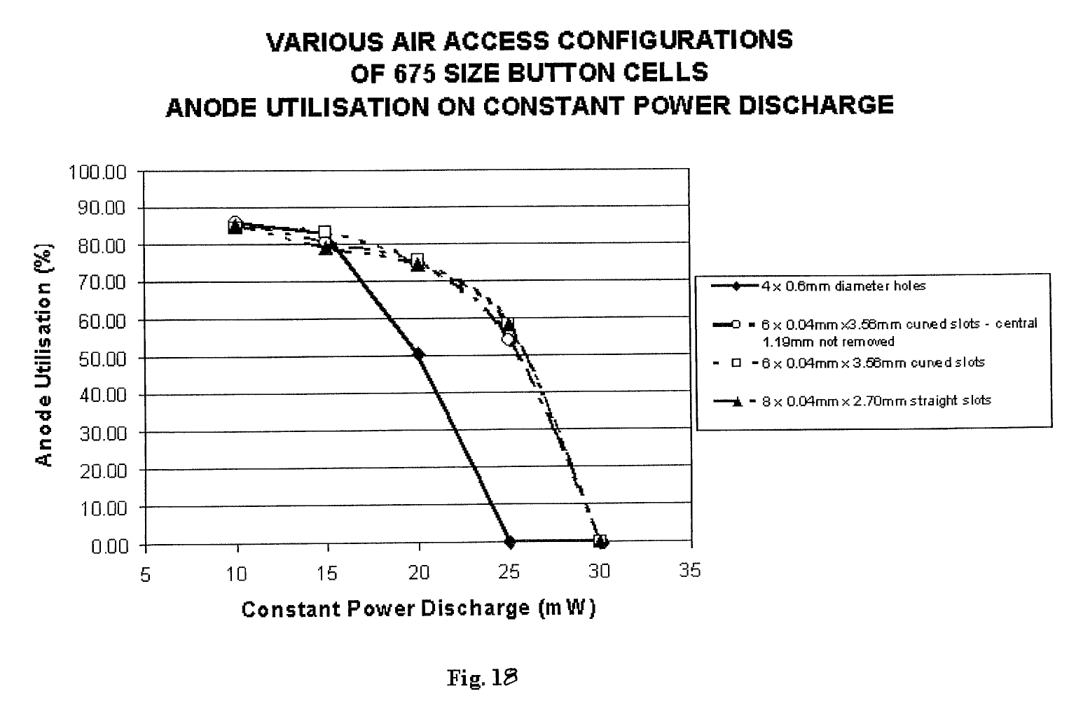

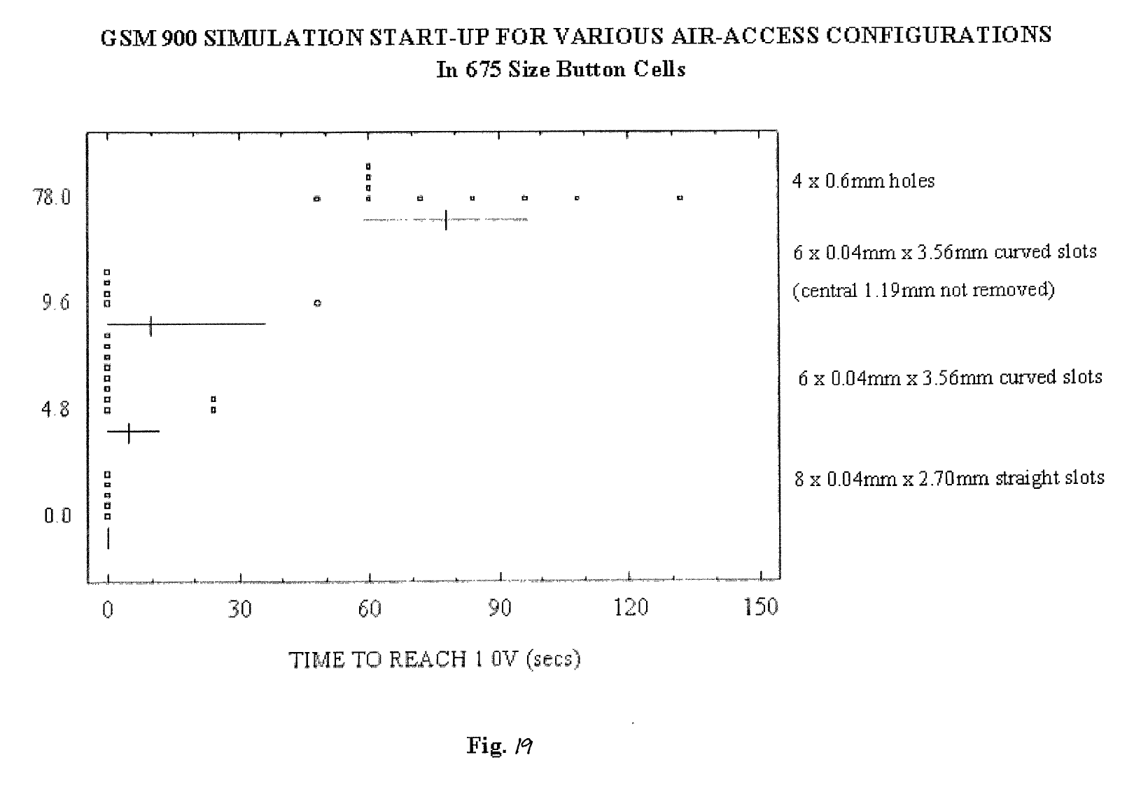

FIG. 18 shows anode utilization the multiple embodiments of cells described above under constant power discharge. The improved energy density may be related to improved anode utilization on constant power discharges of between 20-30 mW. FIG. 18 also shows, among other things, that a 675 size button cell having slots can produce relatively high power output, e.g., about 20 to about 27.5 milliwatts.

FIG. 19 is a plot of time (in seconds) for a GSM 900 high pulse voltage for multiple samples of the multiple embodiments of cells to exceed about 1.0volt. FIG. 19 shows that the time for the cell voltage to rise above 1.0V under this regime is reduced for the slotted air access configurations. For the cells tested, cells having slots were able to produce a GSM high pulse voltage greater than 1.0 volt without significant delay.

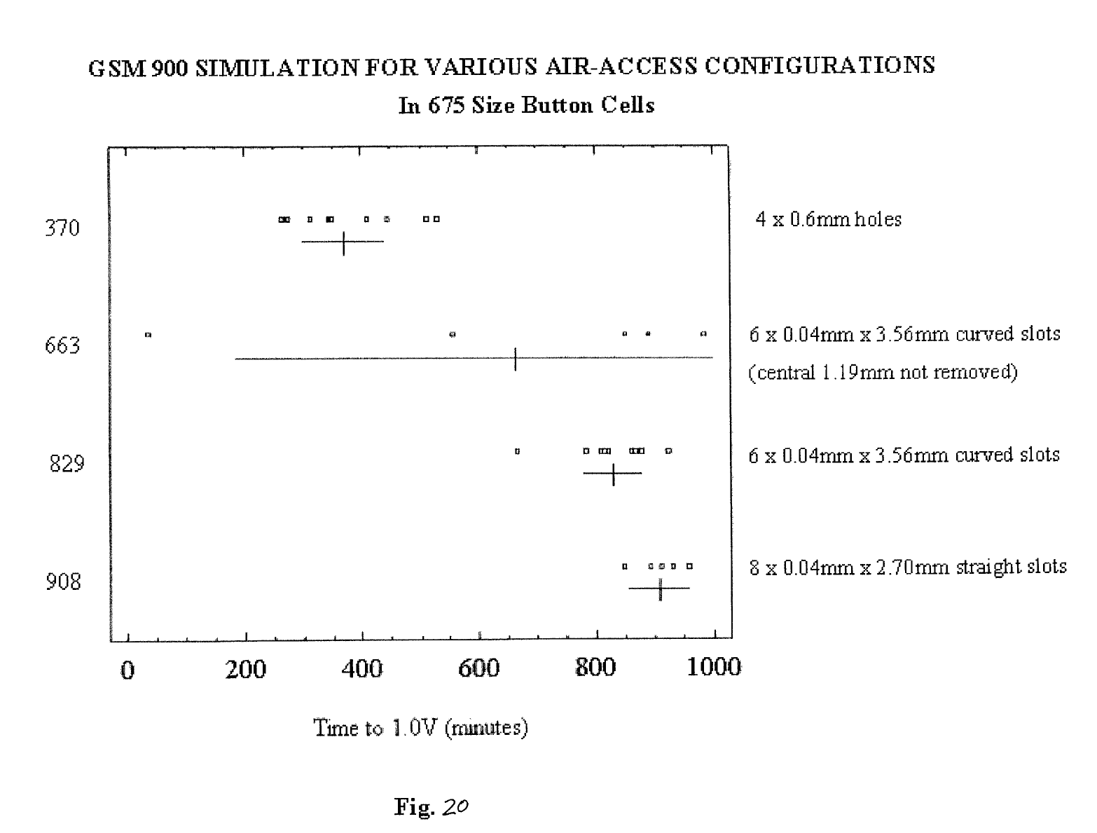

FIG. 20 is a plot of time (in minutes) for the running voltage of multiple embodiments of cells, under GSM 900 simulation, to reduce to less than about 1.0 volt. Cells with slotted air access configurations generally have relatively long lives and therefore high capacity.

Other embodiments are in the claims.

### Appendix A

### Oxygen Supply in a Zinc-Air Cell

1. Introduction

The following sections describe some theories used for the CFD simulation of airflow and oxygen diffusion and convection through cathode can openings of a metal-air cell. Boundary conditions and assumptions are explained.

2. Conservation Equations

When a metal-air cell is in discharge, it consumes oxygen and forms zinc oxide. As the surrounding environment supplies oxygen, the total mass of the cell should increase. For fluid dynamics analysis, only the gas volume in the plenum between the can and the cathode is of interest, and this volume is considered to be constant. The gas inside the plenum will observe the law of mass conservation.

2.1 Mass Conservation Equation

The mass conservation equation has the form of [Fluent, 1998]

$$\frac{\partial ρ}{\partial t} + ρ \frac{\partial {u}_{x}}{\partial x} + ρ \frac{\partial {u}_{y}}{\partial y} + ρ \frac{\partial {u}_{z}}{\partial z} = 0$$

where ρ is density (g/cm³), uₓ, u_{y} and u_{z} are velocity components (cm/s) in the directions x, y and z, respectively.

2.2 Mass Conservation for Fluid with N Species

The mass conservation equation for one of the N species in a fluid is [Fluent, 1998]

$$ρ ( \frac{\partial {c}_{n}}{\partial t} + {u}_{x} \frac{\partial {c}_{n}}{\partial x} + {u}_{y} \frac{\partial {c}_{n}}{\partial y} + {u}_{z} \frac{\partial {c}_{n}}{\partial z} ) = - \frac{\partial {j}_{nx}}{\partial x} - \frac{\partial {j}_{nx}}{\partial y} - \frac{\partial {j}_{nz}}{\partial z} + {q}_{{c}_{n}}$$

where cₙ is the concentration (in mass fraction) of species n (n=1 . . . N), q_{cn} is a source term (g/cm³·s), and jₙ is the diffusive mass flux (g/cm²·s) expressed by Fick's First Law of Diffusion [Crow, 1994], in the s (s=x, y, z) direction,

$${j}_{nx} = - ρ {D}_{n} \frac{\partial {c}_{n}}{\partial s} \qquad ( 2.1 )$$

where Dₙ (or αₙ in some literature) is the mass diffusion coefficient or diffusivity (cm²/s) of species n.

2.3 Momentum Conservation

The Navier-Stokes form of the momentum equations in the s direction is [Zhang, 1986]

$$ρ ( \frac{\partial {u}_{s}}{\partial t} + {u}_{x} \frac{\partial {u}_{s}}{\partial x} + {u}_{y} \frac{\partial {u}_{s}}{\partial y} + {u}_{z} \frac{\partial {u}_{s}}{\partial z} ) = - \frac{\partial p}{\partial s} + μ ( \frac{{\partial }^{2} {u}_{s}}{\partial {x}^{2}} + \frac{{\partial }^{2} {u}_{s}}{\partial {y}^{2}} + \frac{{\partial }^{2} {u}_{s}}{\partial {z}^{2}} ) + ρ {f}_{s}$$

where μ is the dynamic viscosity, p is pressure, and fₓ, f_{y} and f_{z} are the body forces per unit mass, in the directions x, y and z, respectively. For the analyses of gas transport, the effect of body forces can be omitted.

3. Equation of State

For an ideal gas, the equation of state is [Zhang, 1986]

ρ=MP/RT (3.1)

where M is the molecular weight of the gas, and R is the universal gas constant.

For an ideal mixture of gases with N species, there are

$$\frac{1}{M} = {\sum }_{n = 1}^{N} \frac{{c}_{n}}{{M}_{n}} and$$

$${\sum }_{n = 1}^{N} {c}_{n} = 1$$

The total density of the gas is

$$ρ = {ρ}_{1} + {ρ}_{2} + ⋯ + {ρ}_{N} = {\sum }_{n = 1}^{N} {ρ}_{n}$$

where ρₙ=ρcₙ is the density (g/cm³) of species n.

4. Partial Pressure

From the equation of state, equation (3.1), the total pressure is

$$p = \frac{RT ρ}{M} = RT ρ {\sum }_{n = 1}^{N} \frac{{c}_{n}}{{M}_{n}} \\ Let \\ p = {\sum }_{n = 1}^{N} {p}_{n} \qquad ( 4.1 )$$

Then the partial pressure for species n is

$${p}_{n} = \frac{RT ρ {c}_{n}}{{M}_{n}} = {R}_{n} T {ρ}_{n} \qquad ( 4.2 )$$

where Rₙ is the gas constant for species n.

The change in partial pressure of a species in a gas reflects the difference of the species at different positions. A gas tends to reduce the difference in its contents and become uniform. Molecules of the species move from a place with high concentration towards a place with low concentration until the gas becomes uniform. This is the process of diffusion and is explained by Fick's First Law, i.e., equation (2.1), as written in the partial pressure

$${j}_{ns} = - {D}_{n} \frac{{M}_{n}}{RT} \frac{\partial {p}_{n}}{\partial s}$$

This equation shows that the partial pressure acts like real pressure. The mass flux through a unit area during a unit time is proportional to the partial pressure gradient in the direction of the flux.

The volume of the plenum occupied by the gas between the cathode can and the cathode surface is V. The temperature is T. At time t=0, the condition of the gas in the plenum is in its original state, i.e., the same as the ambient. From equation (3.1), there is

$${p}_{a} = \frac{{R}_{a} {Tm}_{a}}{V}$$

where pₐ, Rₐ and mₐ are the total pressure, gas constant and mass of the air in the plenum at t=0, respectively. The total pressure can be expressed as the sum of partial pressures of oxygen and nitrogen. (Here, nitrogen includes the components of nitrogen and other gases except for oxygen.). Then, from equation (4.1), there is

$${p}_{a} = {p}_{oa} + {p}_{na} = \frac{{R}_{o} {Tm}_{oa}}{V} + \frac{{R}_{n} {Tm}_{na}}{V} \qquad ( 4.3 )$$

5. Oxygen Consumption Rate

Suppose the consumption rate of oxygen in the cell is b (g/s), then the oxygen mass mₒ (g) in the plenum equals the difference of the original mₒₐ and the consumed oxygen Δmₒ:

mₒ=mₒₐ−Δmₒ=mₒₐ−bΔt (5.1)

Referring to Faraday's First Law [Moore, 1972]

$$Δ {m}_{o} = \frac{{M}_{o}}{zF} I Δ t$$

where I is the cell current, z is charge number of electrons, and F is the Faraday constant.

The relation of oxygen consumption rate to the current is

$$b = \frac{Δ {m}_{o}}{Δ t} = \frac{{M}_{o} I}{zF} \qquad ( 5.2 )$$

Therefore, the oxygen mass from equation (5.1) becomes

$${m}_{o} = {m}_{oa} - \frac{{M}_{o} I}{zF} Δ t = {ρ}_{a} {c}_{oa} V - \frac{{M}_{o} I}{zF} Δ t \qquad ( 5.3 )$$

6. Differential Pressure in a Metal-Air Cell

Differential pressure Δp is the driving force for convection. For a metal-air cell the differential pressure is the vacuum in the plenum created by the reduction process of the air electrode.

6.1 In a Sealed Cathode Can

Consider a metal-air cell discharged in the sealed condition. At the time t=Δt, the total pressure in the plenum is, according to equation (4.1),

$$p = {p}_{o} + {p}_{n} = \frac{{R}_{o} {Tm}_{o}}{V} + \frac{{R}_{n} {Tm}_{n}}{V} \qquad ( 6.1 )$$

In the plenum, only oxygen is consumed. If there is no extra airflow into the plenum, then nitrogen mass mₙ=mₙₐ.

Using all the values known in equation (6.1), the differential pressure is

$$Δ p = {p}_{a} - p = {p}_{a} ( 0.1896 - 0.7154 \frac{{m}_{o}}{{m}_{na}} ) \qquad ( 6.2 )$$

When all the oxygen inside is consumed, i.e., mₒ=0, the maximum vacuum that the cell may create is Δpₘₐₓ=0.1896 pₐ.

Substitute mₒ in equation (6.2) with its relation to current, equation (5.3), then the differential pressure in relation with current I (mA) becomes

$$Δ p = 5.932 \times {10}^{- 8} \frac{{p}_{a} I}{{m}_{na}} Δ t = 63.12 \frac{I}{V} Δ t$$

6.2 In a Can with Air-access Ports

If the airflow rate through the air-access ports is Q_{f} (cm³/s), the mass of air coming into the plenum is

Δm_{f}=ρₐQ_{f}Δt

The partial pressure increase because of the mass increase in the plenum is, by applying equation (4.2),

$$Δ {p}^{′} = \frac{{R}_{a} T Δ {m}_{f}}{V} = \frac{{R}_{a} {T}_{{ρ}_{a}} {Q}_{f}}{V} Δ t = \frac{{p}_{a} {Q}_{f}}{V} Δ t$$

The total differential pressure is

Δp=(6.226×10⁻⁵I−Q_{f})pₐ/VΔt (6.4)

The condition of this equation is Δp≦0. If Δp=0, then

Q_{fmax}=6.226×10⁻⁵I

This is the maximum airflow rate the current can generate on condition that there were no other forces such as pumping. The proportion of oxygen provided by convection to the total oxygen consumption is

$$\frac{Δ {m}_{of}}{Δ {m}_{o}} = \frac{{ρ}_{a} {c}_{o} zF}{{M}_{o}} \frac{{Q}_{f}}{I} = 3045 \frac{{Q}_{f}}{I} = 0.1896$$

Thus, it is believed that the highest oxygen proportion from convection is 19%. The rest 81% of oxygen will be provided through diffusion. Although convection itself does not contribute much of the oxygen, its influence to the cell performance could be reflected by its effect on diffusion.

6.3 Comparison with Test Data

The following is an example to show the use of the theoretical analysis of the differential pressure with a set of test data published in the literature [Ohta, 1997]. The test was to measure the differential pressure changes of a test metal-air cell as electrochemical reduction of oxygen. The cell was partially sealed with a leakage of Q_{f}=9.3×10⁻⁶ cm³/s. The volume of the plenum was volume V=8.1 cm³. The constant discharge current of the cell was I=5.2 mA.

The vacuum changes in the plenum with time is, using equation (6.4),

Δp=(6.226×10⁻⁵I−Q_{f})Pₐ/VΔt=39.34Δt

The chart below shows the comparison of the theoretical analysis and the test. There are some discrepancies and the difference increases with time. Consider that the maximum vacuum a metal-air cell can produce is about 192000 dyne/cm² and the theoretical value at the end of test nearly reaches the maximum. This may mean that either the test cell could not keep the current because of low oxygen concentration or the leakage was increased because of higher differential pressure.

[image]

A revised form of the differential pressure change can be written to correlate the test data, which is Δp=34.25 Δt and it is shown by the dotted line in the chart.

7. Conclusions

The following are some assumptions and boundary conditions concluded from the theories of fluid dynamics of the air management of a metal-air cell to be used in the CFD simulation.

1. The use of oxygen in a metal-air cell creates a vacuum pressure in the cathode plenum. This vacuum draws air into the plenum through the air-access openings.

2. There is a convection flow of air that provides the cell with less than 19% of the total oxygen it uses.

3. Over 81% oxygen comes from diffusion.

4. The oxygen consumption rate of a metal-air cell per mA current is 8.291×10⁻⁸ g/s.

5. The maximum vacuum a metal-air cell may get in the cathode plenum is about 192000 dyne/cm² or 0.192 atm.

6. The maximum airflow rate that a metal-air cell could may create per mA current is 6.226×10⁻⁵ cm³/s.

It is assumed that the cathode surface is flat and uniform and that it can consume the oxygen that reaches its surface. Therefore, the CFD simulation does not consider the variations in the cathode properties.

### REFERENCES

Crow, D. R., Principles and Applications of Electrochemistry, Fourth Edition, Blackie Academic and Professional, 1994

Fluent Inc., FIDAP 8 Theory Manual, Vol. 5, 1998

Moore, W. J., Physical Chemistry, Fifth Edition, Longman, 1972 Ohta, A., et al., The design of air-holes in button type of zinc-air cells I. New evaluation method of both water vapor and oxygen permeabilities, Denki Kagaku (in Japanese for Electrochemistry), Vol. 65, No. 5, 1997

Zhang, Y., Liuti Lixie (in Chinese for Fluid Dynamics), Gaodeng Jiaoyu Chubanshe, 1986

What is claimed is:

1. A battery, comprising:
a housing;
an anode in the housing;
a cathode in the housing; and
a separator between the cathode and the anode;
the housing having a surface adjacent to the cathode, the surface defining an opening adapted to facilitate a generally non-circular flux of gas on a portion of the cathode,
wherein the opening is not a louver.

2. The battery of claim 1, wherein the flux of gas is generally oval.

3. The battery of claim 1, wherein the flux of gas is generally curvilinear.

4. The battery of claim 1, wherein the surface defines openings adapted to facilitate, in combination, the generally non-circular flux of gas.

5. The battery of claim 4, wherein the openings are circular.

6. The battery of claim 4, wherein the openings are elongated.

7. The battery of claim 1, wherein the opening is elongated.

8. The battery of claim 7, wherein the opening is generally straight.

9. The battery of claim 7, wherein the opening is curved.

10. The battery of claim 1, wherein the surface defines openings symmetrically positioned in the housing.

11. The battery of claim 1, wherein the battery is a metal-air battery.

12. The battery of claim 1, wherein the battery is a button cell.

13. The battery of claim 1, wherein the battery is a prismatic battery.

14. A battery, comprising:
a housing;
an anode in the housing;
a cathode in the housing; and
a separator between the cathode and the anode;
the housing having a surface adjacent to the cathode, the surface defining an opening having an aspect ratio greater than 1,
wherein the opening is not a louver.

15. The battery of claim 14, wherein the aspect ratio is between about 3:2 and about 400:1.

16. The battery of claim 14, wherein the aspect ratio is between about 5:1 and about 50:1.

17. The battery of claim 14, wherein the aspect ratio is between about 15:1 and about 30:1.

18. The battery of claim 14, wherein the aspect ratio is between about 18:1 and about 26:1.

19. A battery, comprising:
a housing;
an anode in the housing;
a cathode in the housing; and
a separator between the cathode and the anode;
the housing having a surface adjacent to the cathode, the surface defining an elongated opening,
wherein the opening is not a louver.

20. The battery of claim 19, wherein the opening is substantially rectangular.

21. The battery of claim 19, wherein the opening has a width between about 0.005 mm and about 0.50 mm.

22. The battery of claim 19, wherein the opening has a width between about 0.02 mm and about 0.16 mm.

23. The battery of claim 19, wherein the opening has a width between about 0.04 mm and about 0.08 mm.

24. The battery of claim 19, wherein the opening has a length between about 0.05 mm and about 20.00 mm.

25. The battery of claim 19, wherein the opening has a length between about 0.20 mm and about 4.00 mm.

26. The battery of claim 19, wherein the opening has a length between about 0.60 mm and about 1.20 mm.

27. The battery of claim 19, wherein the opening is substantially straight.

28. The battery of claim 19, wherein the opening is curved.

29. The battery of claim 19, wherein the surface defines openings symmetrically positioned in the housing.

30. The battery of claim 19, wherein the battery is a button cell, and the housing comprises a cathode can having the surface.

31. The battery of claim 30, wherein the opening extends radially from the center of the cathode can.

32. The battery of claim 30, wherein the cathode can defines openings symmetrically positioned in the cathode can.

33. The battery of claim 30, wherein the surface defines between 4 and 12 openings symmetrically positioned and extending radially from the center of the housing.

34. The battery of claim 30, wherein the surface defines between 8 and 12 openings symmetrically positioned and extending radially from the center of the housing.

35. The battery of claim 30, wherein the cathode can defines rows, each row comprising multiple, collinear elongated openings.

36. The battery of claim 35, wherein the cathode defines between 4 and 12 rows symmetrically positioned and extending radially from the center of the housing.

37. The battery of claim 36, wherein each row comprises between two and four elongated openings.

38. The battery of claim 35, wherein the cathode defines between 5 and 8 rows symmetrically positioned and extending radially from the center of the housing.

39. The battery of claim 38, wherein each row comprises between two and four elongated openings.

40. The battery of claim 19, wherein the surface defines rows, each row comprising multiple elongated openings.

41. A metal-air battery capable of generating a Global System for Mobile pulse voltage greater than about 1.0 volt in less than about 30 seconds.

42. The metal-air battery of claim 41, capable of generating the pulse voltage in less than 20 seconds.

43. The metal-air battery of claim 41 capable of generating the pulse voltage in less than 10 seconds.

44. The metal-air battery of claim 41, capable of generating the pulse voltage in less than 5 seconds.

45. The metal-air battery of claim 41, capable of generating the pulse voltage essentially instantaneously.

46. The metal-air battery of claim 41, wherein battery comprises a housing defining an elongated opening that is not a louver.

47. A metal-air battery capable of undergoing a Global System for Mobile 900 simulation without dropping below about 1.0 volt for at least about 10 hours.

48. The battery of claim 47, capable of undergoing the simulation for at least about 12 hours.

49. The battery of claim 47, capable of undergoing the simulation for at least about 14 hours.

50. The battery of claim 47, wherein battery comprises a housing defining an elongated opening that is not a louver.

51. The battery of claim 1, wherein the flux is elongated.

52. The battery of claim 1, wherein the battery is a cylindrical battery.

53. The battery of claim 14, wherein the battery is a cylindrical battery.

54. The battery of claim 19, wherein the battery is a cylindrical battery.

55. A battery cartridge, comprising:
a casing;
a battery in the casing, the battery comprising an elongated opening; and
a slide moveably engaged with the casing, the slide comprising an elongated opening alignable with the elongated opening of the battery.

56. The cartridge of claim 55, wherein
the slide is moveable between a first position in which the opening of the slide is aligned with the opening of battery, and a second position in which the opening of the slide is misaligned with the opening of battery.

57. The cartridge of claim 56, wherein
the slide is further moveable to a third position in which the opening of the slide is partially aligned with the opening of the battery.

58. The cartridge of claim 55, wherein the casing has a prismatic shape.

59. The cartridge of claim 58, wherein the casing has the shape of a rectangular prism.

60. The cartridge of claim 55, wherein the battery has a rectangular cross section.

61. The cartridge of claim 55, wherein the battery has a triangular cross section.

62. The cartridge of claim 1, wherein the battery is a metal-air battery.

63. An electrochemical power source, comprising:
a metal-air battery system including an elongated opening and air control member arranged for relative sliding motion to variably cover the opening for controlling exposure to an oxygen-containing environment.

64. A battery cartridge, comprising:
a casing;
a battery in the casing, the battery comprising:
a cathode having a first side and a second side,
a first layer disposed adjacent to the first side of the cathode, the first layer being electrically-insulating;
an anode disposed adjacent to the first layer; and
a second layer disposed adjacent to the second side of the cathode, the second layer being air-permeable and liquid-impermeable and defining an exterior surface of the battery; and
a slide moveably engaged with the casing, the slide defining an elongated opening.

65. The battery of claim 64, wherein the battery is a metal-air battery.

66. The battery of claim 64, wherein the cathode has a substantially rectangular cross section.

67. The battery of claim 64, wherein the cathode has a substantially square cross section.
